(19) United States
(12) Patent Application Publication
(10) Pub. No.: US 2013/0170410 A1
(43) Pub. Date: Jul. 4, 2013

(54) SYSTEM AND METHOD OF EXTENDING AN ETHERNET SIGNAL

(71) Applicant: Daniel Hillel Nitzan, Palo Alto, CA (US)

(72) Inventor: Daniel Hillel Nitzan, Palo Alto, CA (US)

(21) Appl. No.: 13/589,324

(22) Filed: Aug. 20, 2012

Related U.S. Application Data
(60) Provisional application No. 61/525,750, filed on Aug. 20, 2011.

(51) Int. Cl. H04L 12/56

(52) U.S. Cl. CPC H04L 45/60
USPC 370/296; 370/400

(57) ABSTRACT

In one exemplary embodiment, an Ethernet system includes an Ethernet networking device coupled with an edge device and at least one destination device via an Ethernet cable. The Ethernet networking device includes an equalizing interface. The Ethernet system also contains an equalizing interface including an equalizing receiver and an equalizing transmitter. The equalizing receiver provides a gain to a first signal received from the edge device that is substantially a loss value of the first signal in the Ethernet cable. The equalizing transmitter provides a gain to a second signal transmitted to the edge device that is substantially a loss value of the first signal in the Ethernet cable. The Ethernet system also includes an edge device.

### CROSS-REFERENCE TO RELATED APPLICATIONS

This application claims priority from U.S. Provisional Application No. 61/525,750, titled SYSTEM AND METHOD OF EXTENDING AN ETHERNET SIGNAL and filed Aug. 20, 2011. The provisional application is hereby incorporated by reference in its entirety.

### BACKGROUND

1. Field

This application relates generally to Ethernet networking, and more specifically to a system and method of extending an Ethernet signal between an augmented and a conventional Ethernet device.

2. Related Art

In existing Ethernet systems, if at least one of two Ethernet devices is a conventional Ethernet device and the working distance between the two Ethernet devices is longer than one hundred (100) meters, the two Ethernet devices may not exchange data normally and may not provide adequate PoE power to the powered Ethernet edge device. While this limitation is acceptable for most short-distance office applications (e.g. personal computers, IDF closets, etc.), it can pose a problem for devices at the perimeter of buildings (e.g. edge devices such as IP security cameras, access control devices, etc.), which are often at further distances. Further, an augmented Ethernet device supports communication and power at extended distances with a conventional remote device. This allows a conventional Ethernet device to inter-operate with augmented devices without the need fbr a media converter at the conventional device. Such an architecture provides extended performance for a wide variety of conventional devices, saving equipment and installation labor cost while providing improved system reliability through fewer system components. Thus, a system and method are required for extending Ethernet signals.

### BRIEF SUMMARY OF THE INVENTION

In one exemplary embodiment, an Ethernet system includes an Ethernet networking device or devices (a hub, switch, or router) coupled to one or more conventional edge devices via Ethernet cable(s). The Ethernet networking device includes an equalizing interface, including an equalizing receiver and an equalizing transmitter. The equalizing receiver provides a gain to the signal received from the edge device that is substantially equivalent to the receive-path cable loss. Both the transmit-path and the receive-path are within the same multi-pair cable and have substantially the same signal loss. Therefore, for proper signal levels, the equalizing transmitter optimally provides a substantially similar gain to that of the receiver's gain.

In one exemplary embodiment, the equalizing interface includes a differential driver and a differential receiver. To minimize crosstalk sensitivity, the Ethernet system typically comprises a 10Base-T Ethernet system operating in a half-duplex mode.

In one exemplary embodiment, to obtain greater PoE power distance performance, PoE power is delivered either with higher voltage (e.g. 56 VDC) or by utilizing all four wire-pairs, or both. Such a method is supported in part due to the 802.3af or 802.3 at requirement that edge devices, also known as “Powered Devices” or “PDs” support either mode A (e.g. RJ45 pins 1&2 and 3&6) or mode B (e.g. pins 4&5 and 7&8). Edge devices are therefore equipped to receive power over all four wire-pairs.

### BRIEF DESCRIPTION OF THE DRAWINGS

The present application can be best understood by reference to the following description taken in conjunction with the accompanying figures, in which like parts may be referred to by like numerals.

FIG. 1 depicts a block diagram of a system adapted to deliver Ethernet signals at extended distances without the use of a repeater and/or edge-device adapter.

FIG. 2 depicts an example equalizing interface circuit 200 according to one or more embodiments.

FIG. 3 depicts a flowchart of an example process of implementing an extended Ethernet network according to one embodiment.

### DETAILED DESCRIPTION

Disclosed are a system, method, and article of manufacture of searching extending an Ethernet signal. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, attendee selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### A. ENVIRONMENT AND ARCHITECTURE

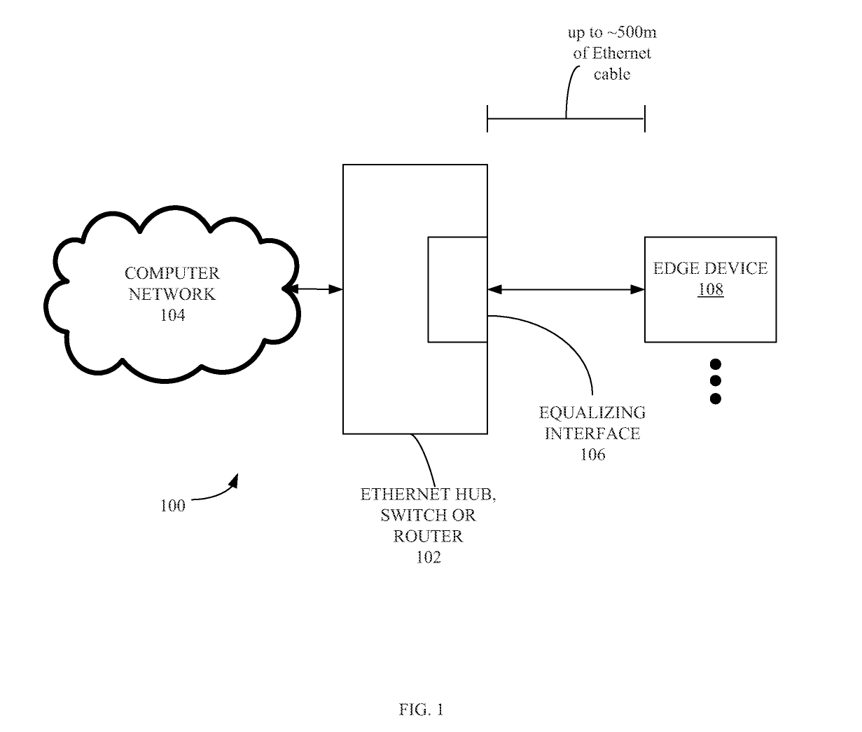

FIG. 1 depicts a block diagram of a system 100 adapted to deliver Ethernet signals at extended distances without the use of a repeater and/or edge-device adapter. Optionally, system 100 may be adapted to include power-over-Ethernet (NE). PoE (e.g. IEEE 802.3 at-2009 or 802.3 af) can include a system to pass electrical power, along with data, on the Ethernet cabling of system 100.

As used herein, Ethernet can typically refer to frame-based computer networking technologies for local area networks (LAN) (e.g. utilizing IEEE 802.3 standards and protocols). Generally, Ethernet technologies use shared bus topology and carrier sense multiple access (CSMA) techniques such as CSMA/CD. Various example types of Ethernet technology can be utilized herein, such as basic Ethernet or Fast Ethernet and the like. Computer network 102 can include an extension of the Ethernet network and/or be coupled with other computer networks such as a wide area network (WAN), the Internet and the like. Various other edge devices, target devices, hosts, servers, database systems can be coupled via computer network 104.

System 100 can include an Ethernet networking device (e.g. an Ethernet hub, switch and/or router) 102. In the various embodiments, Ethernet networking device 102 can be adapted to a connect Ethernet network segments. Ethernet networking device 102 can further be adapted to provide an Ethernet signal (e.g. communicate an Ethernet frame) over longer distances (e.g. ˜300-˜500 meters). For example, Ethernet networking device 102 can be configured to include an equalizing interface 106. Optionally, Ethernet networking device 102 can be configured to deliver tow-voltage power at a distance (e.g. by generating a PoE signal) that is compatible with edge device 108.

Equalizing interface 106 can include circuitry for transmitting and receiving Ethernet signals. Equalizing interface 106 can be adapted to transmit and receive an Ethernet signal for distances greater than one-hundred meters and up to five-hundred meters. For example, a receiving circuit can be configured to include a gain (e.g. a measure of the ability of a circuit, such as an amplifier, to increase the power or amplitude of a signal) that is similar to the signal loss of the Ethernet cable at a distance between the Ethernet networking device 102 and the edge device 108.

Edge device 108 can be any device configured to couple with an Ethernet hub, switch and/or router employing a low outbound (such as transmission from 106 to 108) Ethernet frame rate such as a video camera e.g. an IP surveillance camera), remote sensors and/or access control equipment. Typically, edge device 108 can include a standard Ethernet interface (e.g. are not required to include an equalizing interface similar to 108). For example, in some embodiments, edge device 108 can be a video camera or system that delivers streaming video to a host on network 104. Data can be communicated between edge device 108 and Ethernet networking device 102 utilizing any suitable cable such as a suitable twisted pair cable (e.g. UTP, Category 3 or higher cable).

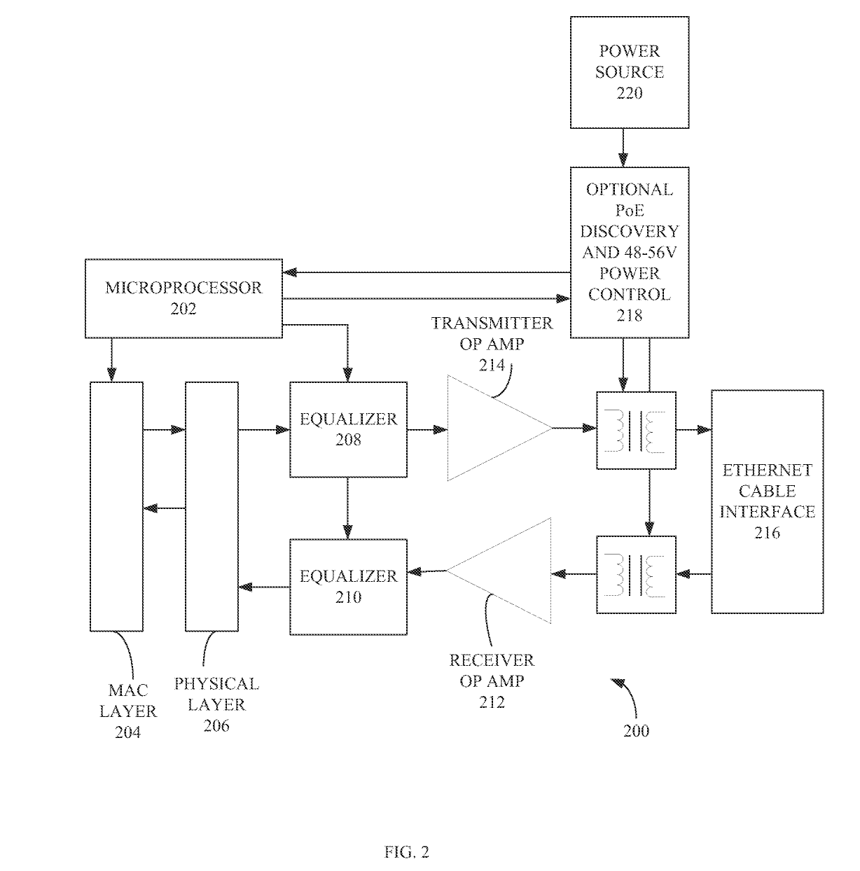

FIG. 2 depicts an example equalizing interface circuit 200 according to one or more embodiments. Circuit 200 includes a microprocessor 202, or other state controller, that can control the various functions of the components of circuit 200 in order to implement the extended Ethernet system 100 of FIG. 1. Microprocessor 202 can accept and implement instructions (e.g. software, firmware, etc.) from other systems such as an Ethernet hub, switch and/or router in which the circuit 200 resides. Media Access Control (MAC) layer 204 can include various devices and functionalities that are configured to implement link sub-layer data communication protocol protocols. Physical layer 206 can include various devices and functionalities that are configured to connect the MAC layer 204 to a physical medium (e.g. Ethernet cable interface). Physical layer 206 device can include a Physical Coding Sublayer (PCS) and/or a Physical Medium Dependent (PMD) layer. Physical layer 206 can encode and/or decode the data that is transmitted and received.

Equalizers 208-210 can perform various equalization operations (such as those provided supra in the description of FIG. 1) that provide sufficient gain to compensate for some or all signal loss during transmission through an Ethernet cable.

In one embodiment, equalizing receiver 208 can include an operation amplifier 210 with a high-frequency boost. The value of the boost can be either continuously adjustable and/or achieved through a selection of taps. Each tap can include a pre-selected receiving gain contour. In one example, a high-frequency receiving gain may be thirty decibels (dB).

Other methods for controlling the receiving gain include, inter alia, approximating the receiving gain value, testing for errors and then manually performing adjustments. Another example includes measuring a received amplitude and then selecting a receiving gain value appropriate for the measured amplitude. In this example, edge device 108 can transmit periodic (e.g. sync) pulses and/or Ethernet frames. These signals can be used for calibration of the receiving gain value.

In yet another example, for non-PoE applications and/or those with power on pins 4, 5, 7, and 8 of a modular RJ45 connecting device (e.g. of an 8P8C connector), an ‘ohmmeter’ can be provided in the equalizing interface and the correct receiving gain can be selected based on the wire's direct current (DC) resistance. Equalizing interface 106 can include a coupling transformer with a resistance of substantially one ohm, in one example. Moreover, this transformer can remove any DC from the Ethernet signal. A small current can then be inserted onto the wire, either momentarily (such as at startup), or continuously, without disturbing the Ethernet signal. The voltage on the wire loop can correspond to wire length. For example, a test current of 3 milliamps onto 400 meters of 24 American wire gauge (AWG) Cat5 wire distance, will yield a voltage of 190 mlllivolts. If the wire is 500 meters of 23 AWG Cat6, the measured voltage could be also be 190 millivolts. Since the difference in signal tosses between these two scenarios is negligible, one can select the correct receiving gain regardless of wire category.

In one embodiment, equalizing transmitter 210 can control transmitting gain of the Ethernet signal to an edge device. For example, equalizing transmitter 210 can include an equalizer and an operation amplifier 214 with a high-frequency boost. The transmitting signal gain can be adjusted according to the signal loss in the Ethernet cable to an edge device, In various embodiments, the value of the boost can be either continuously adjustable in a similar manner as the value of the receiving gain described above. In some embodiments, equalizing transmitter 210 can include a differential driver integrated circuit (IC), such as those manufactured for Digital Subscriber Line (DSL) interfaces, to serve this purpose in a compact and cost-effective manner. Because this wire path has the same attenuation as the receiving path, the transmitting gain can be set to be the same value as that may be appropriate for the more easily measured receiving path. Alternately, a separate ohmmeter test can be deployed.

Ethernet cable interface 216 can be adapted to interface with an Ethernet cable connector. Optional PoE discovery and 48V through 56V power control module 218 can be configured to implement PoE. Module 218 can obtain power from power source 220.

In a particular embodiment, edge devices, such as internet protocol (IP) surveillance cameras and/or access control devices, use low bandwidth transmit signals (transmission from 106 to 108) to generate occasional frames for control and acknowledgment operations, while high bandwidth signals, such as streaming video (transmission from 108 to 106), operate at low amplitude. This means that the system can operate at quasi-peak levels as may be required by electromagnetic compatibility (EMC) protocols. It should be noted that this particular embodiment can operate with “bursts” (e.g. operation of a data network in which data transmission is interrupted at specified intervals) of Ethernet frames, such as with 10Base-T Ethernet. Since the control and acknowledgment operation of transmitting traffic is less frequent, the Ethernet systems mode can be reverted to half-duplex transmission without measurable performance degradation. Crosstalk issues can then be minimized by utilizing one active path at a time during transmission of the Ethernet signals from the Ethernet hub. In this particular embodiment, the system can be used for concentrating streaming video from multiple cameras or other edge devices, for delivery to one or more destination devices. Destination devices can be communicatively coupled to computer network 104. Example destination devices include: hybrid digital video recorder (DVR); network video recorder (NVR); on- or off-site live video viewing; an access control server; and/or other similar controllers. In the particular embodiment, router functions can be optional because edge device traffic (e.g. streaming video or other) can be directed to the same place. What router functions that are utilized can be placed at more centralized locations in the hierarchy. Example functions include: dynamic host configuration protocol (DHCP); security operations such as firewall and/or password; network address translation (NAT); and/or routing table operations.

### B. OPERATION

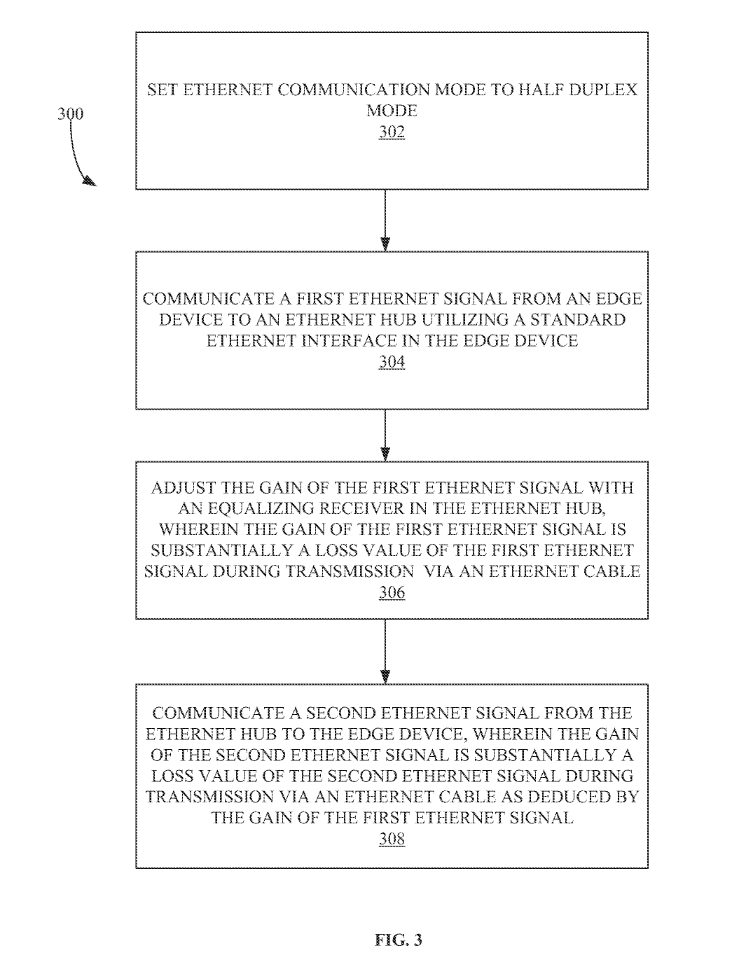

Regarding FIG. 3, for purposes of simplicity of explanation, the one or more methodologies shown herein, e.g., in the form of a flow chart or sequential illustration, are shown and described as a series of acts, it is to be understood and appreciated that the subject innovation is not limited by the order of acts, as some acts may, in accordance with some embodiments, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with some embodiments.

FIG. 3 depicts a flowchart of an example process 300 of implementing an extended Ethernet network according to one embodiment. In step 302 of process 300, the Ethernet communication mode is set to half-duplex mode. In step 304, a first Ethernet signal can be communicated from an edge device to an Ethernet hub utilizing a standard Ethernet interface in the edge device. In step 306, the gain of the first Ethernet signal is adjusted with an equalizing receiver in the Ethernet hub, wherein the gain of the first Ethernet signal is substantially a loss value of the first Ethernet signal during transmission via an Ethe et cable. In step 308, a second Ethernet signal (e.g. a control signal for the edge device) is communicated from the Ethernet hub to the edge device. The gain of the second Ethernet signal can be substantially a loss value of the second Ethernet signal during transmission via an Ethernet cable as deduced by the gain of the first Ethernet signal. In one example, the second Ethernet signal amplitude can be time averaged by quasi-peak measurements in radiated-emissions compliance testing. The systems, circuits, and method of FIGS. 1-2 can be utilized to implement the method of FIG. 3.

### C. CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a non-transitory machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. An Ethernet system comprising:
an Ethernet networking device coupled an edge device and at least one destination device with an Ethernet cable, wherein the Ethernet networking device comprises an equalizing interface;
an equalizing interface comprising an equalizing receiver and an equalizing transmitter, wherein the equalizing receiver provides a gain to a first signal received from the edge device that is substantially a loss value of the first signal in the Ethernet cable, and wherein the equalizing transmitter provides a gain to a second signal transmitted to the edge device that is substantially a loss value of the first signal in the Ethernet cable; and
an edge device.

2. The Ethernet system of claim 1, wherein the second signal comprises a control signal.

3. The Ethernet system of claim 1, wherein the edge device comprises an internet protocol (IP) surveillance camera.

4. The Ethernet system of claim 1, wherein the Ethernet system operates in a half-duplex mode when the second signal is transmitted to the edge device.

5. The Ethernet system of claim 1, wherein the equalizing interface further comprises a receiving amplifier configured to provide a high frequency boost equalizing gain of substantially thirty decibels when the Ethernet cable is substantially three-hundred meters.

6. The Ethernet system of claim 1, wherein the equalizing interface comprises a differential driver integrated circuit.

7. The Ethernet system of claim 1, wherein the Ethernet system comprises a 10Base-T Ethernet system.

8. The Ethernet system of claim 1, wherein the second Ethernet signal amplitude is time averaged by quasi-peak measurements in accordance with a radiated-emissions compliance standard.

9. The Ethernet system of claim 1, wherein the Ethernet system operates in a half-duplex mode when the equalizing interface transmits an Ethernet signal to the edge device.

10. The Ethernet system of claim 1, wherein the first Ethernet signal comprises a received video signal from or to a network video recorder.

11. The Ethernet system of claim 1, wherein an amplitude of the second Ethernet signal is time averaged by quasi-peak measurements according to a radiated-emissions compliance standard.

12. The Ethernet system of claim 1, wherein the networking and the edge devices are exchanged, such as would be used to stream video or other data to an edge device.

13. A method of extending an Ethernet signal comprising:
communicating a first Ethernet signal from an edge device to an Ethernet network utilizing an Ethernet interface in the edge device;
increasing the gain of the first Ethernet signal with an equalizing receiver in the an Ethernet hub, wherein a first Ethernet signal gain comprises substantially a loss value of the first Ethernet signal during transmission via an Ethernet cable;
setting the Ethernet communication mode of the Ethernet hub to a half-duplex mode; and
communicating a second Ethernet signal from the Ethernet hub to the edge device, wherein a second Ethernet signal gain comprises a loss value of the second Ethernet signal during transmission of the second Ethernet signal during transmission via the Ethernet cable.

14. The method of claim 13, wherein the loss value of the second Ethernet signal is determined from the loss value of the first Ethernet signal during transmission via the Ethernet cable.

15. The method of claim 14, wherein the edge device comprises an Internet protocol (IP) surveillance camera.

16. The method of claim 15, wherein the second Ethernet signal comprises a control signal.

17. The method of claim 16, wherein the equalizing interface comprises a differential driver integrated circuit.

18. The method of claim 17, further comprising:
time averaging the second Ethernet signal amplitude by at least one quasi-peak measurement according to a radiated-emissions compliance standard.

19. The method of claim 18, wherein the second Ethernet signal passes electrical power and data.
